(19) United States
(12) Patent Application Publication
(10) Pub. No.: US 2026/0284865 A1
(43) Pub. Date: Sep. 24, 2026

(54) HANDLING SYSTEM AND CONTROL METHOD THEREOF

(71) Applicant: COMPAL ELECTRONICS, INC., Taipei City (TW)

(72) Inventors: Cheng-Shiue Jan, Taipei City (TW); Chia-Shin Weng, Taipei City (TW)

(73) Assignee: COMPAL ELECTRONICS, INC., Taipei City (TW)

(21) Appl. No.: 19/568,711

(22) Filed: Mar. 16, 2026

Related U.S. Application Data
(60) Provisional application No. 63/776,256, filed on Mar. 23, 2025.

(51) Int. Cl. B25J 9/00; B25J 5/00; B25J 9/16

(52) U.S. Cl. CPC B25J 9/0096; B25J 5/007; B25J 9/1669

(57) ABSTRACT

A handling system and a control method thereof are provided. The system includes a mobile vehicle, a robotic arm, a lifting mechanism, a first sensor, a second sensor, and at least one controller. The controller controls a platform of the lifting mechanism to perform a first movement according to a target height detected by the first sensor. In response to the first movement, the controller controls the platform to perform a second movement according to a height difference between the platform and a target position, where the height difference is measured by the second sensor. Therefore, accuracy and stability of alignment of the handling system could be effectively improved.

### CROSS-REFERENCE TO RELATED APPLICATION

This application claims the priority benefit of U.S. provisional application Ser. No. 63/776,256, filed on Mar. 23, 2025. The entirety of the above-mentioned patent application is hereby incorporated by reference herein and made a part of this specification.

### BACKGROUND

### Technical Field

The disclosure relates to an automation technology, and more particularly, to a handling system and a control method thereof.

### Description of Related Art

With rapid development of industrial automation and smart warehousing technologies, handling systems such as an autonomous mobile robot (AMR) or an automated guided vehicle (AGV) are increasingly widely used in material handling, production line collaboration, and logistics sorting. One of core tasks of the systems is to move and place objects precisely from one position to another target position.

In many high-precision application scenarios, such as plugging and unplugging servers in data centers, transferring wafer carriers in semiconductor production lines, or stacking goods in automated warehouses, the handling systems are not only required to lift the objects to a target height, but also require extremely high accuracy and stability in an alignment process thereof. Even the slightest error in height may lead to failure of object placement and damage to the objects themselves or equipment at a target position (such as cabinets or shelves), or even trigger more serious system errors.

### SUMMARY

The disclosure provides a handling system and a control method thereof, which may achieve fast, stable, and high-precision height alignment.

In the embodiment of the disclosure, a handling system is provided. The handling system includes (but is not limited to) a mobile vehicle, a robotic arm, a lifting mechanism, a first sensor, a second sensor, and a controller. The robotic arm is disposed on the mobile vehicle and is configured to clamp an object. The lifting mechanism is disposed on the mobile vehicle and has a platform for placing the object. The first sensor is configured to detect a target height corresponding to a target position. The second sensor is configured to measure a height difference between the platform and the target position. The controller is electrically connected to the aforementioned elements, and is configured to control the platform to perform a first movement according to the target height, and control the platform to perform a second movement according to the height difference in response to the first movement.

In the embodiment of the disclosure, a control method is provided. The control method includes (but is not limited to) the following steps. A handling system is provided. The handling system includes a robotic arm, a lifting mechanism, a first sensor, a second sensor, and a controller. The robotic arm is configured to clamp an object, and the lifting mechanism has a platform for placing the object. Next, a target height corresponding to a target position is detected by the first sensor. Then, a height difference between the platform and the target position is measured by the second sensor. The controller first controls the platform to perform a first movement according to the target height, and then control the platform to platform a second movement according to the height difference in response to the first movement of the platform.

Based on the above, in the embodiment of the disclosure, a two-stage control flow of “the first movement” and “the second movement” is provided. Specifically, the system first quickly moves the platform to a vicinity of the target position according to the target height detected by the first sensor (i.e., the first movement, which may be regarded as a coarse adjustment procedure). Subsequently, the remaining tiny height difference is directly measured by using the second sensor, and the compensatory second movement (i.e., a fine tuning procedure) is performed according to this precise difference value. This control strategy of “coarse adjustment first, followed by fine tuning” not only ensures a speed of alignment but also significantly improves final positioning accuracy and stability, thereby effectively avoiding a risk of damage to the object or equipment due to the height difference.

In order for the aforementioned features and advantages of the disclosure to be more comprehensible, embodiments accompanied with drawings are described in detail below.

### BRIEF DESCRIPTION OF THE DRAWINGS

FIG. 1 is a block diagram of a handling system according to an embodiment of the disclosure.

FIG. 2 is a schematic perspective view of a handling system according to an embodiment of the disclosure.

FIG. 3 is a block diagram of a mobile vehicle according to an embodiment of the disclosure.

FIG. 4A is a schematic perspective view of a mobile vehicle according to an embodiment of the disclosure.

FIG. 4B is a schematic top view of a mobile vehicle according to an embodiment of the disclosure.

FIG. 4C is a schematic bottom view of a mobile vehicle according to an embodiment of the disclosure.

FIG. 5 is a block diagram of a robotic arm according to an embodiment of the disclosure.

FIG. 6 is a schematic perspective view of a robotic arm according to an embodiment of the disclosure.

FIG. 7 is a block diagram of a lifting mechanism according to an embodiment of the disclosure.

FIG. 8 is a schematic perspective view of a lifting mechanism according to an embodiment of the disclosure.

FIG. 9 is a schematic view of a handling system in an application scenario according to an embodiment of the disclosure.

FIG. 10 is a flowchart of an operation of a handling system according to an embodiment of the disclosure.

FIG. 11 is a flowchart of a control method according to an embodiment of the disclosure.

### DETAILED DESCRIPTION OF DISCLOSED EMBODIMENTS

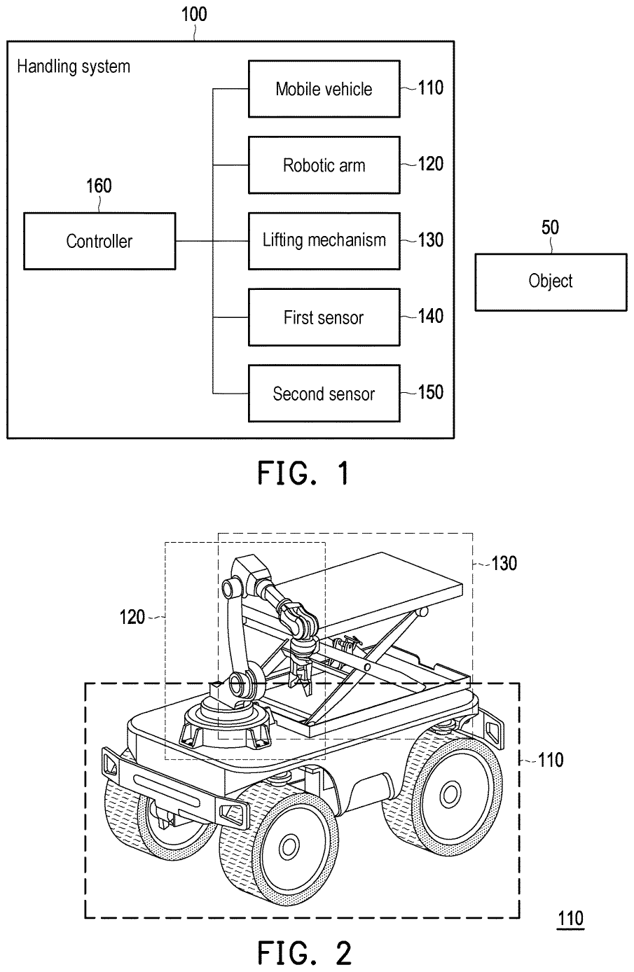

FIG. 1 is a block diagram of a handling system 100 according to an embodiment of the disclosure, and FIG. 2 is a schematic perspective view of the handling system 100 according to an embodiment of the disclosure. Referring to FIGS. 1 and 2, the handling system 100 may be used in fields such as automated warehouses, smart factories, or data centers to perform a handling and placing operation on an object 50 (such as server hosts, cargo boxes, or raw materials).

The handling system 100 includes (but is not limited to) a mobile vehicle 110, a robotic arm 120, a lifting mechanism 130, a first sensor 140, a second sensor 150, and one or more controllers 160.

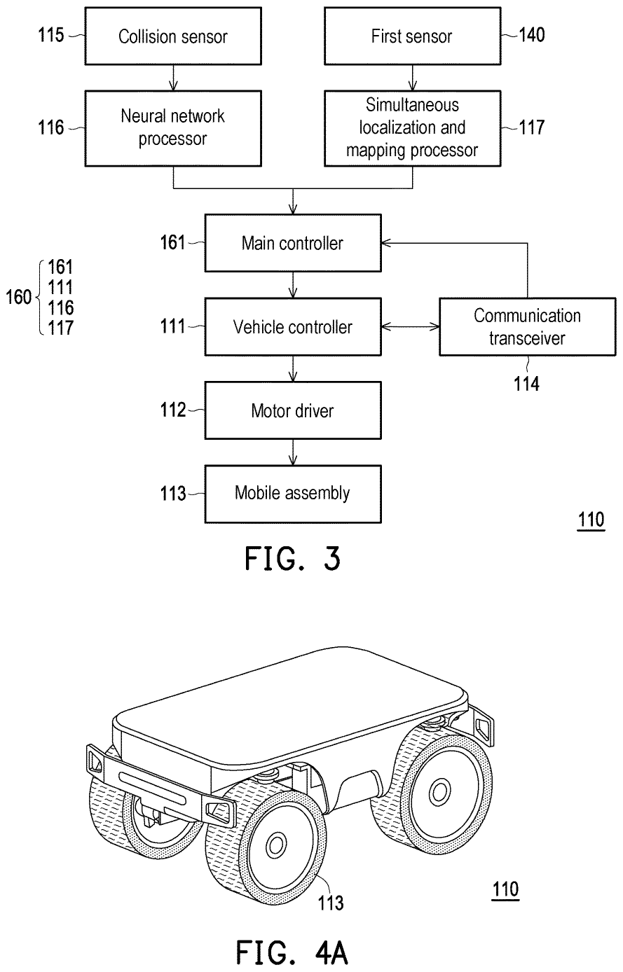

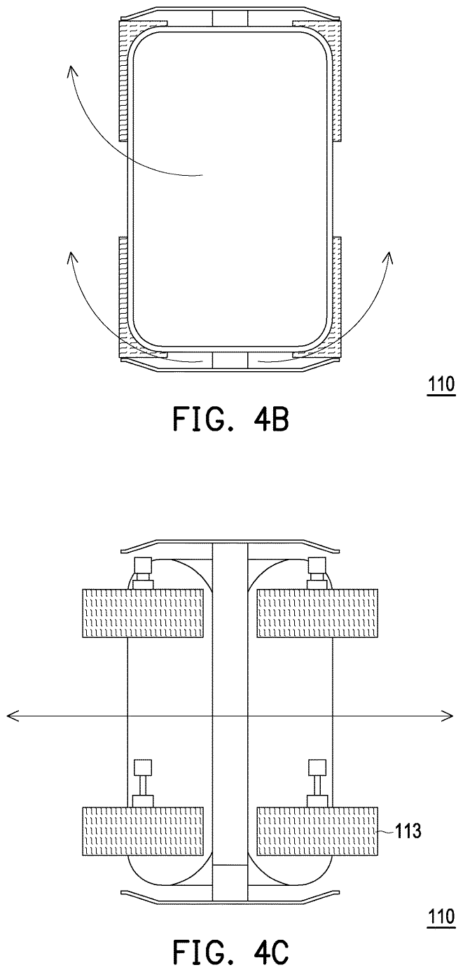

FIG. 3 is a block diagram of the mobile vehicle 110 according to an embodiment of the disclosure. FIG. 4A is a schematic perspective view of the mobile vehicle 110 according to an embodiment of the disclosure. FIG. 4B is a schematic top view of the mobile vehicle 110 according to an embodiment of the disclosure. FIG. 4C is a schematic bottom view of the mobile vehicle 110 according to an embodiment of the disclosure. Referring to FIGS. 3 and 4A to 4C, the mobile vehicle 110 may be an autonomous mobile robot (AMR), an automated guided vehicle (AGV), or other unmanned vehicles. The mobile vehicle 110 includes (but is not limited to) a main controller 161, a vehicle controller 111, a motor driver 112, a mobile assembly 113, a communication transceiver 114, a collision sensor 115, a neural network processor 116, and a simultaneous localization and mapping processor 117.

The main controller 161 may be a central processing unit (CPU), a microcontroller (MCU), or an embedded system. In an embodiment, one or more main controllers 161 are used to perform or lead all or a part of operations of the mobile vehicle 110 or the handling system 100. For example, it is responsible for navigation operations, control of drivers, processing of sensors, and control of decisions for the mobile vehicle 110.

The vehicle controller 111 is electrically connected to the main controller 161. The vehicle controller 111 may be a central processing unit (CPU), a microcontroller (MCU), or an embedded system. In an embodiment, the vehicle controller 111 is used to receive and parse navigation and task instructions from the upper main controller 161, and coordinate internal operation of the mobile vehicle 110, such as path tracking, motor driving, speed control, and status monitoring.

The motor driver 112 is electrically connected to the vehicle controller 111. The motor driver 112 may be a power electronic circuit. In an embodiment, the motor driver 112 receives a power control signal from the vehicle controller 111 to be converted into a current to drive a motor in the mobile assembly 113, thereby controlling a rotational speed and/or a direction of a wheel of the mobile assembly 113.

The mobile assembly 113 may be multiple wheels or a track structure. As shown in FIGS. 4A and 4C, the mobile assembly 113 may be specifically implemented as four sets of Mecanum wheels or omnidirectional wheels. This design enables the mobile vehicle 110 to move in all directions, including forward, backward, lateral, and rotation in place, thereby exhibiting excellent mobility in a narrow space.

The communication transceiver 114 is electrically connected to the main controller 161 and the vehicle controller 111. The communication transceiver 114 may be a transceiver circuit or a wired transmission interface (e.g., USB or UART) that conforms to wireless communication protocols such as Wi-Fi, Bluetooth, 5G, or Zigbee, and may be used to establish a stable data network with other elements or other external systems.

The collision sensor 115 may be an ultrasonic sensor, an infrared sensor, an image sensor, or a physical collision bar. In an embodiment, the collision sensor 115 is used to detect surrounding obstacles, so that main controller 161 may plan a path to avoid the obstacles.

The neural network processor 116 is electrically connected to the collision sensor 115 and the main controller 161. The neural network processor 116 may be a dedicated hardware accelerator such as a graphic processing unit (GPU), a tensor processing unit (TPU), or a field programmable gate array (FPGA). The neural network processor 116 may execute algorithms such as advanced path planning based on artificial intelligence, dynamic obstacle avoidance based on sensing data of the collision sensor 115, or visual servoing. For example, precise positioning may be achieved through a marker (a QR code or an augmented reality mark), short-range positioning may be assisted by an infrared signal, and positioning accuracy may be improved by a magnetic sensor detecting changes in ground magnetic strips or magnetic fields.

The simultaneous localization and mapping (SLAM) processor 117 is electrically connected to the main controller 161 and the first sensor 140. The simultaneous localization and mapping processor 117 may be a dedicated digital signal processor (DSP), graphic processing unit (GPU), field programmable gate array (FPGA), or a software module running on a high-performance CPU. In an embodiment, the simultaneous localization and mapping processor 117 is used to simultaneously calculate a posture and a position of the mobile vehicle 110, and construct a map of a surrounding environment according to the first sensor 140 (e.g., LiDAR, the image sensor, a motion sensor (e.g., an inertial measurement unit (IMU)), or a combination thereof, which will be described in detail below).

In some application scenarios, the mobile vehicle 110 may further include an emergency stop button for stopping the operation of the handling system 100 or other devices, and/or may further include an over-the-air update module for remotely updating a navigation algorithm and/or sensor calibration.

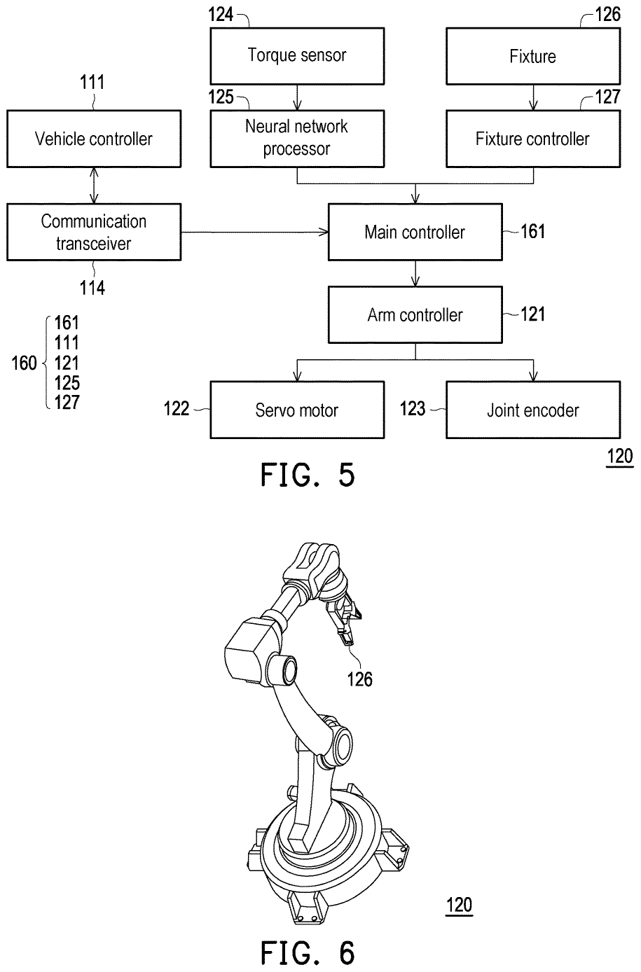

FIG. 5 is a block diagram of the robotic arm 120 according to an embodiment of the disclosure, and FIG. 6 is a schematic perspective view of the robotic arm 120 according to an embodiment of the disclosure. Referring to FIGS. 5 and 6, the robotic arm 120 includes (but is not limited to) the main controller 161 (which may be shared with the mobile vehicle 110, or there may be multiple main controllers 161, and the main controllers 161 transmit or receive data through the communication transceiver 114), an arm controller 121, a servo motor 122, a joint encoder 123, a torque sensor 124, a neural network processor 125, a fixture 126, and a fixture controller 127.

Reference may be made to the above descriptions for the main controller 161, which will not be repeated in the following.

The arm controller 121 is electrically connected to the main controller 161. The arm controller 121 may be a dedicated motion controller or a microcontroller. In an embodiment, the arm controller 121 is used to receive and parse motion trajectory instructions from the upper main controller 161 to be converted into target angles, velocities, and accelerations required for each of joints, and control instructions for the fixture controller 127 through calculation of inverse kinematics.

The servo motor 122 is electrically connected to the arm controller 121. The servo motor 122 may include a motor body, a driver, and a feedback sensor. In an embodiment, the servo motor 122 is used to drive multiple joints (3 to 6-axis joints) of the robotic arm 120, so that the robotic arm 120 may move flexibly in a three-dimensional space, for example, multi-directional movement: grabbing, rotating, lifting, or aligning. In some application scenarios, the servo motor 122 may be used with a reducer to improve torque accuracy.

The joint encoder 123 is electrically connected to the arm controller 121. The joint encoder 123 may be disposed at each of the joints. In an embodiment, the joint encoder 123 is used to provide real-time feedback on an actual rotation angle of each of the joints.

The torque sensor 124 may be a six-axis force/torque sensor or a pressure sensor based on a strain gauge. In some application scenarios, the torque sensor 124 may be installed on a wrist of the robotic arm 120 or the fixture 126, and used to detect changes in force and torque generated when in contact with an external environment, so as to achieve flexible gripping or collision detection. In some embodiments, the robotic arm 120 may assist in identifying a target position by using the image sensor (e.g., a camera or a laser range finder), and/or detect magnetic marks and improve alignment accuracy by using the magnetic sensor.

The neural network processor 125 is electrically connected to the main controller 161 and the torque sensor 124. The neural network processor 125 may be a graphic processing unit (GPU) or an application specific integrated circuit (ASIC) to execute deep learning-based visual servoing algorithms, such as real-time correction of a position of an end point of the robotic arm 120 to be aligned with a target object through a camera image. In some embodiments, the neural network processor 125 may use sensing data of the image sensor (e.g., the camera or the laser range finder) to assist in identifying the target position.

In an embodiment, as shown in FIG. 6, the fixture 126 is disposed at an end of the robotic arm 120 and is used to clamp the object 50, and a form thereof may be a two-finger, three-finger, or adaptive gripper. In an embodiment, the fixture 126 is further provided with a pressure sensor (not shown) to detect a pressure value at the end of the robotic arm 120 (corresponding to the fixture 126).

The fixture controller 127 is electrically connected to the arm controller 121 and the fixture 126. The fixture controller 127 may be a dedicated microcontroller, an integrated motor driver, or software or firmware running on the arm controller 121. In an embodiment, the fixture controller 127 is used to control an opening and closing stroke and clamping force of the fixture 126 according to instructions.

In some embodiments, the robotic arm 120 may be fixed to the mobile vehicle 110 through a screwing member (e.g., a mechanical latch) to improve operation stability.

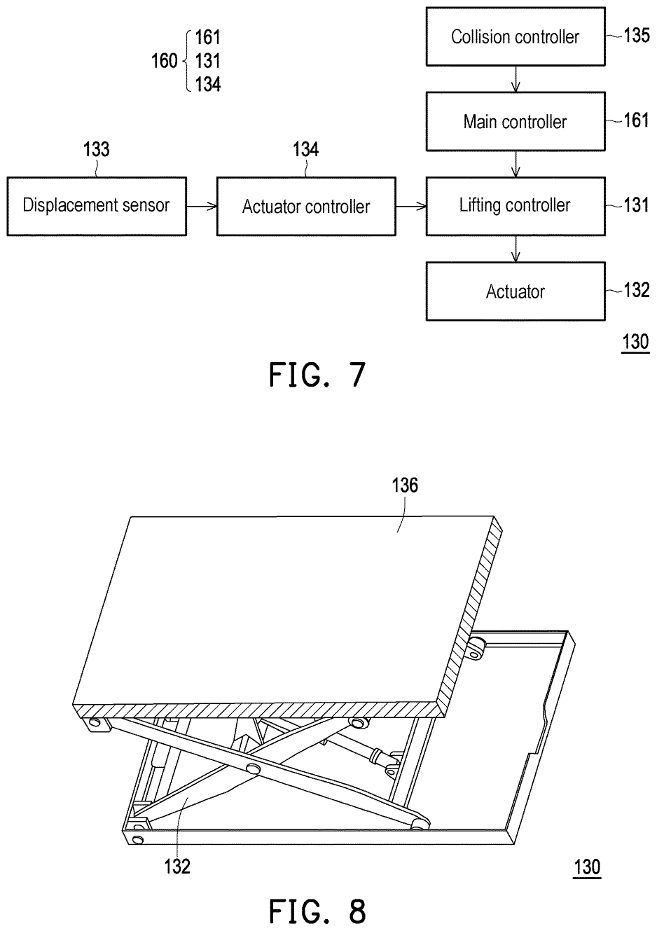

FIG. 7 is a block diagram of the lifting mechanism 130 according to an embodiment of the disclosure, and FIG. 8 is a schematic perspective view of the lifting mechanism 130 according to an embodiment of the disclosure. Referring to FIGS. 7 and 8, the lifting mechanism 130 includes (but is not limited to) the main controller 161 (which may be shared with the mobile vehicle 110, or there may be the main controllers 161, and the main controllers 161 transmit or receive the data through the communication transceiver 114), a lifting controller 131, an actuator 132, a displacement sensor 133, an actuator controller 134, a collision sensor 135, and a platform 136.

Reference may be made to the above descriptions for the main controller 161, which will not be repeated in the following.

The lifting controller 131 is electrically connected to the main controller 161. The lifting controller 131 may be a dedicated programmable logic controller (PLC) or a microcontroller (MCU). In an embodiment, the lifting controller 131 is used to receive adjustment instructions from the upper main controller 161 and execute control algorithms. In an embodiment, the lifting controller 131 is used to receive control amount indications or control signals from the actuator controller 134.

The actuator 132 may be a hydraulic cylinder, a pneumatic cylinder, or an electric actuator driven by a ball screw. For example, a scissor linkage structure is an X-shaped structure that may raise or lower the platform 136 by expanding or retracting. A dual hydraulic cylinder includes a fixed end and a piston rod end. The fixed end is connected to a lower scissor link or a base frame to ensure that the hydraulic cylinder may provide stable support force when the hydraulic cylinder retracts. It is typically located on a lower side of the scissor link near a center to provide an optimal lever ratio, making lifting of the platform 136 more efficient. The piston rod end may be connected to a middle movable fulcrum of an upper scissor link, and moves with the expansion and retraction of the hydraulic cylinder, thereby pushing a scissor mechanism to expand or retract, completing a lifting movement. Alternatively, a dual electric screw features a lightweight design and may provide more precise height adjustment.

The displacement sensor 133 may be an optical scale, a position encoder, or linear potentiometer installed on the mechanism. In an embodiment, the displacement sensor 133 is used to measure and report a current vertical height of the platform 136 in real time.

The actuator controller 134 is electrically connected to the lifting controller 131 and the displacement sensor 133. In an embodiment, the actuator controller 134 is used to a convert logic control signal from the lifting controller 131 into a power signal sufficient to drive the actuator 132. For example, in the embodiment where the actuator 132 is the hydraulic cylinder, the actuator controller 134 may be an electric-controlled proportional valve or a servo valve, and may precisely regulates a flow rate and a direction of hydraulic oil. In an embodiment, the actuator controller 134 integrates a proportional-integral-derivative (PID) control algorithm and is used as a PID controller to calculate a precise control amount according to height feedback from the displacement sensor 133.

The collision sensor 135 may be an ultrasonic sensor, an infrared sensor, or a contact sensor (including a pressure sensing strip). In an embodiment, the collision sensor 135 is used to detect obstacles above or around, so that the main controller 161 or the lifting controller 131 may adjust the lifting to avoid the obstacles.

The collision sensor 135 may be a processing unit that processes a signal from the pressure sensing strip or a proximity sensor to immediately interrupt a lifting operation for safety when an unexpected physical contact is detected during a lifting process. The platform 136 is a planar structure that carries the object 50.

The platform 136 is a planar structure that carries the object 50.

In an embodiment, the lifting mechanism 130 further includes a torque sensor (not shown). The torque sensor is electrically connected to the lifting controller 131 and/or the main controller 161. The torque sensor may be a six-axis force/torque sensor or a pressure sensor based on the strain gauge. In an embodiment, the torque sensor is used to detect a weight value of the object 50 placed on the platform 136.

In an embodiment, as shown in FIG. 2, both the robotic arm 120 and the lifting mechanism 130 are disposed on a machine body of the mobile vehicle 110. The mobile vehicle 110 is responsible for autonomous movement in a work area. The lifting mechanism 130 has a platform as shown in FIG. 8, which is used to carry the object 50 and is responsible for the height adjustment in a vertical direction. The robotic arm 120 is used to clamp the object 50 and transfer the object 50 between the target position and the platform of the lifting mechanism 130.

Referring to FIG. 1, the first sensor 140 is electrically connected to the controller 160. As shown in FIG. 3, the first sensor 140 is electrically connected to the main controller 161. The first sensor 140 may be LiDAR, structured light, or a time-of-flight (ToF) depth camera. The first sensor 140 may be disposed on the mobile vehicle 110 or other devices. In an embodiment, the first sensor 140 is used to perform environmental scanning and positioning, and to initially detect three-dimensional spatial coordinates and/or distance values of the target position (corresponding to a position of the object 50).

The second sensor 150 is electrically connected to the controller 160. The second sensor 150 may be a high-precision (e.g., with an error less than a tolerance) laser triangulation sensor or a confocal displacement sensor. In some application scenarios, the second sensor 150 has higher resolution and refresh rate than the first sensor 140, and is specifically used, for example, to measure a more accurate relative height difference between the platform 136 and the target position (e.g., the position of the object 50 or an adjacent reference object thereof) at close range.

The controller 160 may be a central processing unit (CPU), a graphic processing unit (GPU), or other programmable general-purpose or special-purpose microprocessors, a digital signal processor (DSP), a programmable controller, a field programmable gate array (FPGA), or an application specific integrated circuit (ASIC). The controller 160 is electrically connected to the mobile vehicle 110, the robotic arm 120, the lifting mechanism 130, the first sensor 140, and the second sensor 150. In an embodiment, the controller 160 is used to coordinate the movement of the mobile vehicle 110, the height adjustment of the lifting mechanism 130, and the gripping and placing operations of the robotic arm 120 to complete automated handling tasks.

The one or more controllers 160 may include the main controller 161, the vehicle controller 111, the neural network processor 116, and the simultaneous localization and mapping processor 117 in FIG. 3, the main controller 161, the arm controller 121, the neural network processor 125, and the fixture controller 127 in FIG. 5, and the main controller 161, the lifting controller 131, and/or the actuator controller 134 in FIG. 7.

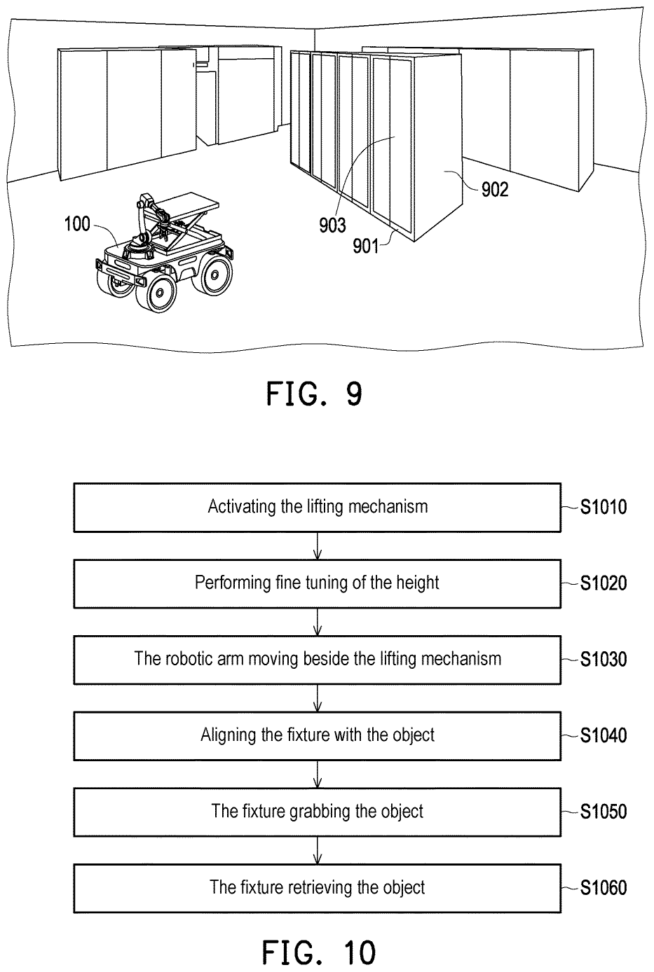

FIG. 9 is a schematic view of the handling system 100 in an application scenario according to an embodiment of the disclosure. Referring to FIG. 9, in this application scenario, multiple cabinets 901 are provided. The cabinet 901 provides multiple slots 902 for placement of a server host 903. In the application scenario of the data center, a task of the handling system 100 is to accurately insert the server host 903 (i.e., the object 50) into the corresponding slot 902 of the cabinet 901 or to remove the server host 903 from the slot 902.

However, the application scenario shown in FIG. 9 is merely an illustrative example, and a user may change the application scenario according to actual requirements thereof. For example, an environment of the application scenario is a logistics factory or a manufacturing plant, but is not limited thereto.

To facilitate understanding of an operation flow in the embodiment of the disclosure, numerous embodiments are provided below to describe the operation flow in the embodiment of the disclosure in detail. The method provided in the embodiment of the disclosure will be described below with reference to the elements or modules shown in FIGS. 1 to 8.

FIG. 10 is a flowchart of an operation of the handling system 100 according to an embodiment of the disclosure. Referring to FIG. 10, a complete operational sequence from lifting alignment to end-point alignment. In step S1010, the lifting mechanism 130 is activated. This step corresponds to a coarse adjustment procedure for the height adjustment. The controller 160 receives multiple input information, such as a height of the target slot 902, a current height of the lifting mechanism 130, and load weight information on the platform 136. Based on the multiple input information, the controller 160 may perform load compensation through a lifting control algorithm (such as PID control) to calculate a rough target height and drive the platform 136 to move quickly to a vicinity of the target height (i.e., a first movement of the platform 136). More specifically, the input information is as follows:
Z_{slot_vision}: a height (e.g., a height of the slot 902 or the server host 903 (i.e., the object 50) in FIG. 9) corresponding to the target position measured by the first sensor 140 (e.g., an RGB-D camera or the laser range finder);
W_{pay_load}: a weight value measured by the torque sensor 124; if the object 50 is placed on the platform 136, the weight value of the object 50 may be measured;
Z_{lift}(t): a height of the platform 136 reported in real time by the displacement sensor 133.

In an embodiment, the controller 160 determines the target height according to a measurement value of the first sensor 140 and the weight value of the object 50. The target height corresponds to the target position (corresponding to the position of the object 50). When there is a load on the platform 136 (e.g., the object 50), the height of the platform 136 may decrease. Therefore, estimation of the target height is required to compensate for the height reduction caused by the load.

In an embodiment, the controller 160 generates a control instruction for the first movement of the platform 136 according to a difference between the height of the platform 136 and the target height (to be used by the lifting controller 131 or the actuator 132 to move the platform 136).

For example, the lifting control algorithm is as follows:

$${Z}_{t arget \_ lift} = {Z}_{slot \_ vision} + {f}_{comp} ( {W}_{pay \_ load} ) \qquad ( 1 )$$

$$( t ) = {Z}_{t arget \_ lift} - {Z}_{lift} ( t ) \qquad ( 2 )$$

$${u}_{lift} ( t ) = {K}_{p} e ( t ) + {K}_{i} \int e ( t ) dt + {K}_{d} \frac{de ( t )}{dt} \qquad ( 3 )$$

Z_{target_lift} is the target height, and e(t) is the difference between the height of the platform 136 and the target height. ƒ_{comp}( ) is a load compensation function, and is used to estimate “an amount of sinking of the platform 136 due to a weight thereof. For example, assuming that the platform 136 is lifted to a target height of 100 cm and has a load of 50 kg (e.g., a weight of the object 50), the platform 136 sinks 2 mm due to structural elasticity (i.e., the height drops to 998.3 mm. Taking FIG. 9 as an example, in the application scenario of moving the server host 903 from the platform 136 to the cabinet 901, the server host 903 is required to be pushed into the slot 902). If the platform 136 is unloaded, the platform 136 will be lifted to 1000.3 mm to be roughly aligned with the target position. Taking FIG. 9 as an example, in the application scenario of moving the server host 903 from the cabinet 901 to the platform 136, the server host 903 is required to be pulled out from the slot 902. Therefore, if a weight value W_{pay_load} is zero, a height Z_{slot_vision} detected by the first sensor 140 may be directly used as the target height corresponding to the target position. A proportional (P) control term Kₚe(t): generating a basic correction amount according to magnitude of a current difference. With rapid response, the greater the difference, the stronger an output, and the faster a reaction speed. A coefficient Ky corresponds to reaction intensity of this control term.
An integral (I) control term Kᵢ∫e(t)dt: generating a correction amount to eliminate a residual difference according to accumulation of past differences. A steady-state error is eliminated, and long-term deviation is avoided. A coefficient Kᵢ corresponds to reaction intensity of this control term.
A differential (D) control term

$${K}_{d} \frac{de ( t )}{dt} :$$

generating a predictive correction amount to suppress oscillation and prevent overshoot according to a speed of change of the difference to improve stability. A coefficient K_{d} corresponds to reaction intensity of this control term.

### Output Information:

An output of the function (1) is the target height Z_{target_lift}, which is the (rough) target height for the first movement of the platform 136.
An output of the function (3) is a control amount corresponding to the control instruction used to control the first movement of the platform 136. This control amount is based on proportional-integral-derivative (PID) control. In other words, the controller 160 may use the proportional-integral-derivative control to determine the control amount corresponding to the control instruction. For example, a motor is driven to rotate a few revolutions with a specific voltage and current, or an electronically controlled valve is opened by 20%.

In step S1020, fine tuning of the height is performed. After the coarse adjustment (i.e., the first movement based on the target height) is completed, the controller 160 receives a real-time feedback value from a higher-precision sensor (e.g., the second sensor 150). This feedback value directly reflects a slight height difference between the platform 136 and the target slot 902 (hereinafter referred to as the height difference). The controller 160 performs the fine tuning according to this height difference through another lifting control algorithm (such as the PID control) to ensure that a position of the platform 136 after a second movement may be accurately aligned with the target position. In other words, the second movement of the platform 136 is the fine tuning of the height in response to the first movement thereof. In some application scenarios, a lifting range of the first movement may be greater than a lifting range of the second movement.

More specifically, the input information is as follows:
Z_{target_lift}: the target height output in step S1010;
ΔZ_{height_difference}: the height difference between the platform 136 and the target position (e.g., a position of the slot 902 in FIG. 9) measured by the second sensor 150.

In an embodiment, the controller 160 may generate a control instruction for the second movement according to the height difference (to be used by the lifting controller 131 or the actuator 132 to move the platform 136).

For example, the lifting control algorithm is as follows:

$${Z}_{final \_ lift} = {Z}_{t arget \_ lift} + {Δ Z}_{height \_ difference} \qquad ( 4 )$$

$${u}_{final \_ lift} ( t ) = {K}_{p}^{fine} Δ {Z}_{height \_ difference} + {K}_{i}^{fine} \int {Δ Z}_{height \_ difference} dt + {K}_{d}^{fine} \frac{{d Δ Z}_{height \_ difference}}{dt} \qquad ( 5 )$$

Z_{final_lift} is a final height of the second movement, and ΔZ_{height_difference} is the height difference between the platform 136 and the target position measured by the second sensor 150. A proportional (P) control term

$${K}_{p}^{fine} Δ {Z}_{height \_ difference} :$$

generating a basic correction amount according to a current height difference. With rapid response, the greater the height difference, the stronger an output, and the faster a reaction speed. A coefficient

$${K}_{p}^{fine}$$

corresponds to reaction intensity of this control term.
An integral (I) control term

$${K}_{i}^{fine} \int Δ {Z}_{{height}_{-} difference} dt :$$

generating a correction amount to eliminate a residual height difference according to accumulation of past height differences. The steady-state error is eliminated, and the long-term deviation is avoided. A coefficient

$${K}_{d}^{fine}$$

corresponds to reaction intensity of this control term.
A differential (D) control term

$${K}_{d}^{fine} \frac{d Δ {Z}_{h e {ight}_{-} difference}}{dt} :$$

generating a predictive correction amount A differential (D) control term to suppress the oscillation and prevent the overshoot according to a speed of change of the height difference to improve the stability. A coefficient

$${K}_{d}^{fine}$$

corresponds to reaction intensity of this control term.

### Output Information:

An output of the function (4) is the final height Z_{final_lift}, which is the (fine) final height for the second movement of the platform 136 to achieve precise alignment.
An output of the function (5) is a control amount corresponding to the control instruction used to control the second movement of the platform 136. This control amount is based on the proportional-integral-derivative control. In other words, the controller 160 may use the proportional-integral-derivative control to determine the control amount corresponding to the control instruction. For example, the motor is driven to rotate a few revolutions with the specific voltage and current, or the electronically controlled valve is opened by 5%.

For example, if the controller 160 detects that the platform 136 is 0.3 mm higher than the target position, the platform 136 will be lowered by 0.3 mm through the control instruction. For another example, if the controller 160 detects that the platform 136 is 1.7 mm lower than the target position, the platform 136 will be lifted by 1.7 mm through the control instruction.

After the precise alignment (i.e., the second movement) of the platform 136 is completed, in step S1030, the robotic arm 120 moves beside the lifting mechanism 130. The controller 160 may perform path planning through algorithms such as inverse kinematics according to a final position of the platform 136 of the lifting mechanism 130 and a current position of the robotic arm 120, and monitor the surrounding environment by using use an obstacle avoidance sensor to ensure that the robotic arm 120 moves safely to a position ready to grab the object 50.

More specifically, the input information is as follows:
(X_{lift},Y_{lift},Z_{final_lift}): a position (X_{lift},Y_{lift}) of the platform 136 located by the simultaneous localization and mapping processor 117 (e.g., based on simultaneous localization and mapping (SLAM)) and the final height Z_{final_lift} of the platform 136 determined in step S1020.
[symbol] _{current}: a current angle of each of the joints sensed in real time by the joint encoder 123.
Mₑₙᵥ: data detected by the collision sensor 115 and/or the collision sensor 135 and used for environmental obstacle avoidance.
τₐᵣₘ={vₘₐₛ, aₘₐₛ, joint limits, . . . }: a parameter set of motion planning, where vₘₐₛ is a maximum velocity, aₘₐₛ is a maximum acceleration, and joint limits is a joint restriction.

In an embodiment, in response to the second movement of the platform 136 (i.e., after the fine tuning of the height of the platform 136), the controller 160 may control a third movement of the robotic arm 120. A position of an end point of this third movement corresponds to a position of an end point of the platform 136 in the second movement. For example, the third movement is to move the robotic arm 120 beside the platform 136.

For example, a path planning algorithm is as follows:

$$( {X}_{initial arm} , {Y}_{initial arm} , {Z}_{initial arm} ) = Position [ Forward Kinematics ( {\vec{θ}}_{c u r rent} ) ] \qquad ( 6 )$$

$$( {X}_{target arm} , {Y}_{target arm} , {Z}_{target arm} ) = ( {X}_{lift} , {Y}_{lift} , {Z}_{final lift} ) \qquad ( 7 )$$

The robotic arm 120 is informed that “please move to the position (X_{lift},Y_{lift}) beside the platform 136 and prepare to grab the object 50 at the final height Z_{final_lift}”. By using a forward kinematics function Forward Kinematics, a current joint angle [symbol] _{current} of the robotic arm 120 is converted into Cartesian coordinates (X_{intial arm},Y_{intial arm},Z_{intial arm}) at an end of a fixture thereof, which is used as a starting point (i.e., an initial position) for the path planning. The target position of the robotic arm 120 is set, so that it moves to the position of the lifting platform 136, and prepare to perform the operation at the final grabbing height of the object 50.

$${P}_{arm} ( t ) = Path Plan ( {X}_{initial arm} , {Y}_{initial arm} , {Z}_{initial arm} \to {X}_{target arm} , {Y}_{target arm} , {Z}_{target arm} ; {M}_{env} , {τ}_{arm} ) \qquad ( 8 )$$

The path planning algorithm Path Plan is called, taking the initial position and the target position as main inputs, and considering a restriction τₐᵣₘ of an environment map Mₑₙᵥ and the robotic arm 120, to output a collision-free path Pₐᵣₘ(t) from the starting point to a target point.
[symbol] _{current}: a current joint angle vector of the robotic arm 120;
X_{intial arm}, Y_{intial arm}, Z_{intial arm}: the initial position of the robotic arm 120;
X_{target arm}, Y_{target arm}, Z_{target arm}: the target position of the robotic arm 120;
X_{lift}, Y_{lift}, Z_{final_lift}: the position of the lifting platform 136 and the final grabbing height of the object 50;
Mₑₙᵥ: environmental information/maps;
τₐᵣₘ the restriction of the robotic arm.
X_{intial arm}, Y_{intial arm}, Z_{intial arm}=>X_{target arm}, Y_{target arm}, Z_{target arm}: main input variables (the initial position and the target position of the robotic arm 120);
Mₑₙᵥ, τₐᵣₘ: environmental parameters or conditional restrictions (boundaries, maps, and restrictions).
   If Pₐᵣₘ(t) has no feasible solution (i.e., obstacle avoidance planning fails), a current motion instruction is paused, and a “path blocked” error code is reported, or a waiting state is entered.

$${\vec{θ}}_{target} ( t ) = Inverse Kinematics ( {X}_{target arm} , {Y}_{target arm} , {Z}_{target arm} , {τ}_{arm} ) . \qquad ( 9 )$$

By using an inverse kinematics function Inverse Kinematics, target Cartesian coordinates (X_{target arm}, Y_{target arm}, Z_{target arm}, τₐᵣₘ) are converted into a target joint angle [symbol] _{target}(t) required for the robotic arm 120 to perform the movement. This step is to convert spatial coordinate instructions, which are understood by humans or systems, into angular instructions that machines may execute.

### Output Information:

The output [symbol] _{target}(t) of the function (9) is a motion trajectory of the control instruction for the third movement. The control instruction for this third movement may be transmitted to the arm controller 121, causing the arm controller 121 to drive the corresponding joint to move or rotate along a safe and smooth trajectory.

In step S1040, the fixture 126 is aligned with the object 50. This step may include using a vision sensor (e.g., the RGB-D camera) and the torque sensor 124 to precisely align the fixture 126 of the robotic arm 120 with the grabbing position of the object 50 (e.g., the server host 903 in FIG. 9).

More specifically, the input information is as follows:
(X_{object},Y_{object},Z_{object}): the position of the object 50 identified by the vision sensor.
[symbol] _{align}: a geometric offset vector (hereinafter referred to as an offset amount) estimated by an image analysis of the neural network processor 125.
F_{contact}(t): end pressure feedback detected by the torque sensor 124.
F_{safe}: preset security parameters of the system.

In an embodiment, the controller 160 may correct an offset amount of the fixture 126 of the robotic arm 120.

For example, an alignment algorithm is as follows:

$$( {X}_{grip} , {Y}_{grip} , {Z}_{grip} ) = ( {X}_{object} , {Y}_{object} , {Z}_{object} ) + {\vec{δ}}_{align} \qquad ( 10 )$$

$${F}_{contact} ( t ) \leq {F}_{safe} \qquad ( 11 )$$

(X_{grip},Y_{grip},Z_{grip}) is a grabbing position of the fixture 126. In other words, the offset amount may be directly added to the position of the object 50 obtained from image recognition to compensate for deviation in the image recognition.

### Output Information:

(X_{grip},Y_{grip},Z_{grip}): the grabbing position of the fixture 126, which is the alignment completed simultaneously through visual and force feedback.

In step S1050, the fixture 126 grabs the object 50. The controller 160 determines the optimal clamping force according to a preset gripping pressure set value, or the weight value of the object 50 and the feedback from the pressure sensor on the fixture 126, and executes a gripping motion through the fixture controller 127.

More specifically, the output information is as follows:
(X_{grip},Y_{grip},Z_{grip}): the grabbing position of the fixture 126.
W_{pay_load}: a load weight measured by the torque sensor (i.e., a weight of the load on the platform 136).
P_{grip_measured}(t): the pressure value reported in real time by the pressure sensor at the end.

In an embodiment, the controller 160 may determine the control instruction (e.g., indicating response intensity) for the fixture 126 according to a weight value of the load on the platform 136 and the pressure value at the end.

For example, a grabbing control algorithm is as follows:

$${P}_{{grip}_{-} target} = f ( {W}_{{pay}_{-} load} ) \qquad ( 12 )$$

where P_{grip_target} represents target clamping pressure or target clamping force. The fixture 126 requires the expected pressure or force to be applied to the object 50 to ensure that the object 50 does not slip during a moving process, and is not damaged at the same time.
where ƒ(W_{pay_load}) is a control mapping function based on design experiences. Models may be built by using linear, piecewise (lightweight low-pressure/middleweight medium-pressure/heavyweight high-pressure), lookup table, or machine learning methods;
ƒ(W_{pay_load}) may be embedded with a safety coefficient α for conservative clamping, such as P_{grip_target}=αW_{pay_load}, α=2.0~3.0.

$${u}_{grip} ( t ) = {K}_{p}^{g} ( {P}_{{grip}_{-} target} - {P}_{{grip}_{-} measured} ( t ) ) \qquad ( 13 )$$

where

$${K}_{p}^{g}$$

is a proportional gain function dedicated to the fixture 126, used to determine the response intensity, and

$${K}_{p}^{g}$$

may be a constant, a lookup table, or an adaptive gain.

The output information is as follows:
u_{grip}(t): the control instruction for the fixture 126 to stabilize clamping and achieve a successful grabbing state.

In step S1060, the fixture 126 retrieves the object 50. The controller 160 plans a motion trajectory of the joints of the robotic arm through a smooth motion planning algorithm. Therefore, taking FIG. 9 as an example, the server host 903 may be smoothly removed from the cabinet 901 and placed on the platform 136, or may be grabbed from the platform 136 and installed into the slot 902 of the cabinet 901.

More specifically, the input information is as follows:
(X_{place},Y_{place},Z_{place}): placement coordinates, which may be (Xₛₗₒₜ,Yₛₗₒₜ,Zₛₗₒₜ) or (X_{lift},Y_{lift},Z_{final_lift}).
[symbol] _{grip}: When grabbing is completed in step S1050, the joint encoder 123 reports the current angle of the joint, which is used to represent a real-time state at the end.
τₐᵣₘ={vₘₐₛ, aₘₐₛ, joint limits, . . . }: the parameter set of the motion planning.
F(t): a force feedback signal (e.g., the pressure value) estimated by torque of the joint or the pressure sensor at the end.
F_{transfer_limit}: a transfer-safe force threshold in a handling task.

A motion control algorithm is as follows:

$${\vec{θ}}_{place} ( t ) = Inverse Kinematics ( {X}_{place} , {Y}_{place} , {Z}_{place} , {τ}_{arm} ) \qquad ( 14 )$$

$${\vec{θ}}_{smooth motion} ( t ) = Smooth Motion ( {\vec{θ}}_{grip} , {\vec{θ}}_{place} ( t ) , {τ}_{arm} ) \qquad ( 15 )$$

where Smooth Motion( ) a smooth motion planning function, used to make a motion process of the robotic arm 120 smoother and less oscillating without violating acceleration/velocity limits. Equivalent implementations exist in robot-related development platforms or algorithm simulation software, with names such as trajectory planner, jtraj, servoj, and motion profile.

$$F ( t ) \leq {F}_{transfer limit} . \qquad ( 15 )$$

The output information is as follows:
[symbol] _{smooth motion}(t): a safe and smooth movement instruction for the robotic arm 120, enabling the object to be successfully aligned or placed on the platform 136.

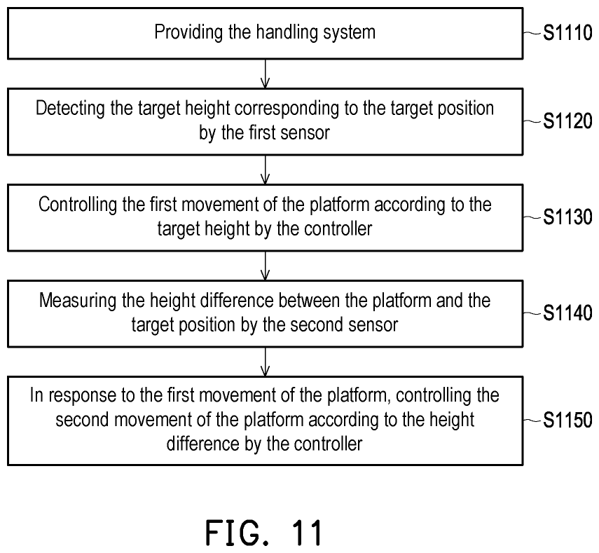

FIG. 11 is a flowchart of a control method according to an embodiment of the disclosure. Referring to FIG. 11, in step S1110, the aforementioned handling system 100 is provided. As described above, the handling system 100 includes the robotic arm 120, the lifting mechanism 130, the first sensor 140, the second sensor 150, and at least one controller 160. The robotic arm 120 is used to clamp the object 50, and the lifting mechanism 130 has the platform 136 for placing the object 50.

In step S1120, the target height corresponding to the target position (e.g., the slot 902 in FIG. 9) is detected by the first sensor 140.

In step S1130, the platform 136 of the lifting mechanism 130 is controlled to perform the first movement according to the target height by the controller 160. In this step, a function of the coarse adjustment in step S1010 in FIG. 10 is implemented.

In step S1140, the height difference between the platform 136 and the target position is measured by the second sensor 150.

In step S1150, in response to the first movement of the platform 136, the platform 136 is controlled to perform the second movement according to the height difference by the controller 160. In this step, a function of the fine tuning in step S1020 in FIG. 10 is implemented.

Reference may be made to the descriptions of FIG. 10 for detailed descriptions of each of the steps in FIG. 11, which will not be repeated in the following.

Based on the above, in the handling system and the control method thereof in the embodiments of the disclosure, the height adjustment process of the platform is divided into the coarse adjustment procedure of “the first movement” and the fine tuning procedure of “the second movement”. The system first uses the first sensor to perform a rough and quick initial alignment, and then uses the high-precision second sensor to perform accurate compensation for the height difference after the first movement. This strategy of “coarse adjustment first, followed by fine tuning”, which combines the mechanisms such as the PID control and the load compensation, not only significantly improves final accuracy and stability of platform alignment, but also takes into account operational efficiency, effectively solving issues of overshoot, oscillation, or steady-state errors that may occur in a single positioning in the related technologies. Therefore, the disclosure provides a more reliable, accurate, and efficient automated handling solution, which is particularly suitable for precision operation scenarios with stringent requirements for height alignment.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A handling system, comprising:
a mobile vehicle;
a robotic arm disposed on the mobile vehicle and configured to clamp an object;
a lifting mechanism disposed on the mobile vehicle and having a platform for placing the object;
a first sensor configured to detect a target height corresponding to a target position, wherein the target position corresponds to a position of the object;
a second sensor configured to measure a height difference between the platform and the target position;
at least one controller electrically connected to the mobile vehicle, the robotic arm, the first sensor, the second sensor, and the lifting mechanism, and configured to:
control a first movement of the platform according to the target height; and
in response to the first movement of the platform, control a second movement of the platform according to the height difference.

2. The handling system according to claim 1, wherein the lifting mechanism further comprises:
a displacement sensor electrically connected to the at least one controller, and configured to detect a height of the platform, wherein the at least one controller is further configured to:
generate a control instruction for the first movement according to a difference between the height of the platform and the target height.

3. The handling system according to claim 2, wherein the lifting mechanism further comprises:
a torque sensor electrically connected to the at least one controller, and configured to detect a weight value of the object, wherein the at least one controller is further configured to:
determine the target height according to a measurement value of the first sensor and the weight value.

4. The handling system according to claim 1, wherein the at least one controller is further configured to:
generate a control instruction for the second movement according to the height difference.

5. The handling system according to claim 4, wherein a control amount corresponding to the control instruction is based on proportional-integral-derivative (PID) control.

6. The handling system according to claim 1, wherein the at least one controller is further configured to:
in response to the second movement of the platform, control a third movement of the robotic arm, wherein a position of an end point of the third movement corresponds to a position of an end point of the platform in the second movement.

7. The handling system according to claim 6, wherein the at least one controller is further configured to:
correct an offset amount of a fixture of the robotic arm.

8. The handling system according to claim 6, wherein the lifting mechanism further comprises:
a torque sensor electrically connected to the at least one controller, and configured to detect a weight value of the object, wherein the weight value is configured to determine a control instruction for a fixture.

9. The handling system according to claim 8, wherein the robotic arm further comprises:
a pressure sensor disposed on a fixture of the robotic arm, electrically connected to the at least one controller, and configured to detect a pressure value at an end of the robotic arm, wherein the at least one controller is further configured to:
determine the control instruction for the fixture according to the weight value and the pressure value.

10. A control method, comprising:
providing a handling system, wherein the handling system comprises a robotic arm, a lifting mechanism, a first sensor, a second sensor, and at least one controller, the robotic arm is configured to clamp an object, and the lifting mechanism has a platform for placing the object;
detecting a target height corresponding to a target position by the first sensor, wherein the target position corresponds to a position of the object;
controlling a first movement of the platform according to the target height by the at least one controller;
measuring a height difference between the platform and the target position by the second sensor; and
in response to the first movement of the platform, controlling a second movement of the platform according to the height difference by the at least one controller.

11. The control method according to claim 10, wherein the lifting mechanism further comprises a displacement sensor, and the control method further comprises:
detecting a height of the platform by the displacement sensor; and
generating a control instruction for the first movement according to a difference between the height of the platform and the target height by the controller.

12. The control method according to claim 11, wherein the lifting mechanism further comprises a torque sensor, and the control method further comprises:
detecting a weight value of the object by the torque sensor; and
determining the target height according to a measurement value of the first sensor and the weight value by the at least one controller.

13. The control method according to claim 11, wherein a step of generating the control instruction for the first movement comprises:
determining a control amount corresponding to the control instruction based on proportional-integral-derivative (PID) control by the at least one controller.

14. The control method according to claim 10, wherein the at least one controller is further configured to:
generating a control instruction for the second movement according to the height difference by the at least one controller.

15. The control method according to claim 14, wherein a step of generating a control instruction for the first movement comprises:
determining a control amount corresponding to the control instruction based on proportional-integral-derivative control by at least one controller.

16. The control method according to claim 10, further comprising:
in response to the second movement of the platform, controlling a third movement of the robotic arm by the at least one controller, wherein a position of an end point of the third movement corresponds to a position of an end point of the platform in the second movement.

17. The control method according to claim 16, further comprising:
correcting an offset amount of a fixture of the robotic arm by the at least one controller.

18. The control method according to claim 16, wherein the lifting mechanism further comprises a torque sensor, the robotic arm further comprises a pressure sensor, and the control method further comprises:
detecting a weight value of the object by the torque sensor, wherein the weight value is configured to determine a control instruction for a fixture.

19. The control method according to claim 18, wherein the robotic arm further comprises the pressure sensor, and the control method further comprises:
detecting a pressure value at an end of the robotic arm by the pressure sensor; and
determining the control instruction for a fixture of the robotic arm according to the weight value and the pressure value by the at least one controller.
